(19) United States
(12) Patent Application Publication
(10) Pub. No.: US 2013/0002176 A1
(43) Pub. Date: Jan. 3, 2013

(54) DRIVE MOTOR CONTROL SYSTEM AND METHOD FOR A VEHICLE

(75) Inventor: Sang Joon Kim, Seoul (KR)

(73) Assignees: Kia Motors Corporation, Seoul (KR); Hyundai Motor Company, Seoul (KR)

(21) Appl. No.: 13/312,593

(22) Filed: Dec. 6, 2011

(30) Foreign Application Priority Data
Jun. 29, 2011 (KR) 10-2011-0063837

(51) Int. Cl. H02P 3/14; G05B 5/01

(52) U.S. Cl. 318/376; 318/460

(57) ABSTRACT

Disclosed is a system and method for reducing vibrations caused by a motor during braking of a vehicle, More specifically, the disclosed technique detects an actual rotational speed of a drive motor, calculates a target rotational speed of the drive motor by filtering the actual rotational speed, calculates a speed difference between the actual rotational speed and the target rotational speed, calculate an offset value by filtering the speed difference, calculate a speed vibration by deducting the offset value from the speed difference, and reduce the speed vibration of the motor by applying a compensated torque in an opposite direction of the speed vibration based on the calculated speed vibration.

### CROSS-REFERENCE TO RELATED APPLICATION

This application claims priority to and the benefit of Korean Patent Application No. 10-2011-0063837 filed in the Korean Intellectual Property Office on Jun. 29, 2011, the entire contents of which are incorporated herein by reference.

### BACKGROUND OF THE INVENTION

(a) Field of the Invention

The present invention relates to a drive motor control method of a vehicle that reduces vibrational elements that are generated between a present rotational speed and a target rotational speed of a drive motor, while a brake is being operated.

(b) Description of the Related Art

Generally, while a hybrid vehicle or an electric vehicle is braking, an anti jerk control program is performed to reduce vibrations that are formed due to the motor. This method includes damping the vibrational element by applying a torque in an opposite direction of the vibration.

In particular, in the conventional systems, hydraulic pressure is applied to a brake, an amount of hydraulic pressure is used to calculate a target vehicle speed, and the output speed of the motor is controlled thereby. Typically a hydraulic pressure sensor is used to calculate this pressure, and however, the precision of these sensors is deteriorated. Additionally, the conventional art does not compensate for proportional application of the brakes to the wheel which is currently receiving power and the wheel that is not currently receiving power, respectively. That is, in modern day drive systems, each wheel is generally receiving a different amount of power depending upon, e.g., detected wheel slippage, steering wheel angulations, etc. Thus, when dynamically applying a brake to these systems it is important to take into account the amount of power applied to each of the wheels respectively.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a drive motor control system and method for a vehicle which effectively calculates a target speed for a motor while a brake is being operated to prevent vibrations from the motor. To do this, the present invention uses an actual rotational speed of the motor to calculate a target rotational speed.

A drive motor control system and method for a vehicle according to an exemplary embodiment of the present invention may include detecting an actual rotational speed of a drive motor, calculating a target rotational speed of the drive motor by filtering the actual rotational speed, calculating a speed difference between the actual rotational speed and the target rotational speed, calculating an offset value by filtering the speed difference, calculating a speed vibration by deducting the offset value from the speed difference, and reducing the speed vibration of the motor by applying a compensated torque in an opposite direction of the speed vibration.

A compensation value may be applied to the speed vibration value, and a first low pass filter may filter the actual rotational speed and a second low pass filter filters the speed difference.

The drive motor may be a motor/generator that uses a regenerative torque that is inputted through the output shaft to generate electricity and charges a battery with the electricity. The drive motor control system and method may further include an internal combustion engine that transforms combustion energy into a rotational torque. The drive motor assists a rotational torque of the engine.

The actual rotational speed of the drive motor may be detected and the actual rotational speed may be filtered to calculate a target rotational speed, when a braking signal is detected.

A vehicle having a motor according to an exemplary embodiment of the present invention may include a drive motor that generates a torque and transfers the torque to an output shaft, and a control portion that controls a rotational speed and a rotational torque of the drive motor, wherein the control portion detects a actual rotational speed of the drive motor, calculates a target rotational speed of the drive motor by filtering the actual rotational speed, calculates a speed difference between the actual rotational speed and the target rotational speed, calculates an offset value by filtering the speed difference, calculates a speed vibrational value by deducting the offset value from the speed difference value, and reduces the speed vibration of the motor by applying a compensated torque in an opposite direction of the speed vibration. Again, the control portion may apply a compensation factor to the speed vibration.

The vehicle having a motor may further include a first low pass filter that filters the actual rotational speed, and a second low pass filter that filters the speed difference. The drive motor may be a motor/generator that uses regeneration torque that is input from the output shaft to generate electricity, wherein the generated electricity charges a battery. The control portion, e.g., a controller, may detect the actual rotational speed of the drive motor and filters the actual rotational speed to calculate the target rotational speed of the drive motor, when a braking signal is detected.

As stated above, the actual rotational speed of the motor/generator is filtered to calculate the target rotational speed and the speed vibration value of the motor/generator is calculated by using the speed difference between the actual rotational speed and the target rotational speed without a separate hydraulic pressure sensor. Thus, vibrations from the motor are effectively reduced.

### BRIEF DESCRIPTION OF TILE DRAWINGS

FIG. 1 is a schematic diagram of a vehicle having a motor according to an exemplary embodiment of the present invention.

FIG. 2 is a flowchart showing a control method of a motor disposed in a vehicle according to an exemplary embodiment of the present invention.

FIG. 3 is a flowchart showing a control method of a motor disposed in a vehicle according to an exemplary embodiment of the present invention.

FIG. 4 is a graph showing a movement of a motor disposed in a vehicle according to an exemplary embodiment of the present invention.

### DETAILED DESCRIPTION OF THE EMBODIMENTS

An exemplary embodiment of the present invention will hereinafter be described in detail with reference to the accompanying drawings.

It is understood that the term “vehicle” or “vehicular” or other similar term as used herein is inclusive of all vehicles in general such as passenger automobiles including sports utility vehicles (SUV), buses, trucks, various commercial vehicles, watercraft including a variety of boats and ships, aircraft, and the like, and includes, internal combustion vehicles, hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

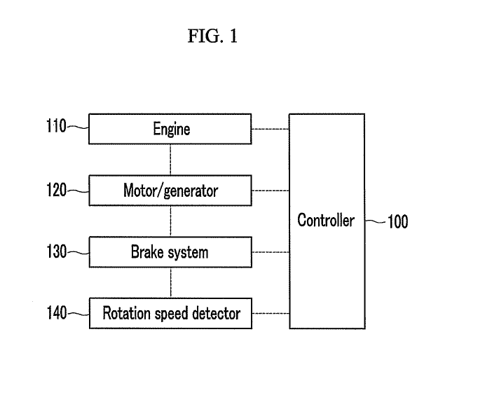

FIG. 1 is a schematic diagram of a vehicle having a motor according to an exemplary embodiment of the present invention. Referring to FIG. 1, the vehicle includes an engine 110, a motor/generator 120, a brake system 130, a rotational speed detector 140, and a control portion 100, e.g., a controller. The present invention can also be applied to an electric vehicle in which the engine 110 is not disposed. If a driver operates a brake pedal or takes his foot off an accelerator, the control portion 100 detects this driving condition and controls the brake system 130 so that the motor/generator 120 is charged or the output rotational speed is controlled thereby.

An actual rotational speed is detected and a target rotational speed is to be calculated to control the output rotational speed of the motor/generator 120 in an exemplary embodiment of the present invention. The rotational speed detector 140 detects a rotational speed of the output shaft of the motor/generator 120 and transfers the detected signal to the control portion 100.

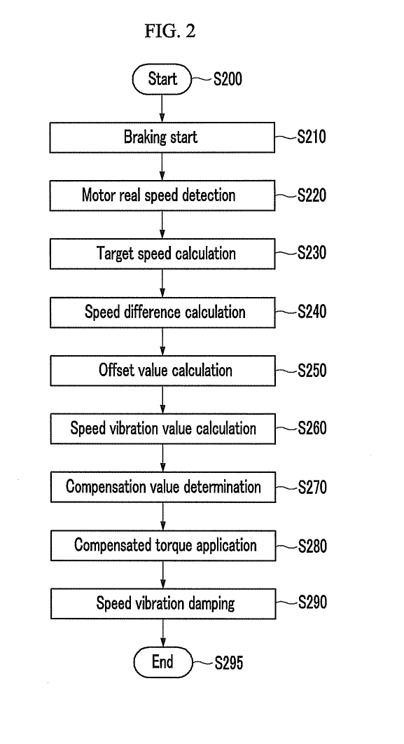

Referring to FIG. 2 to FIG. 4, the control method of the motor/generator is described. FIG. 2 is a flowchart showing a control method of a motor disposed in a vehicle according to an exemplary embodiment of the present invention. Referring to FIG. 2, the control is started by the control portion 100 in S200 and braking is activated by a driver in S210.

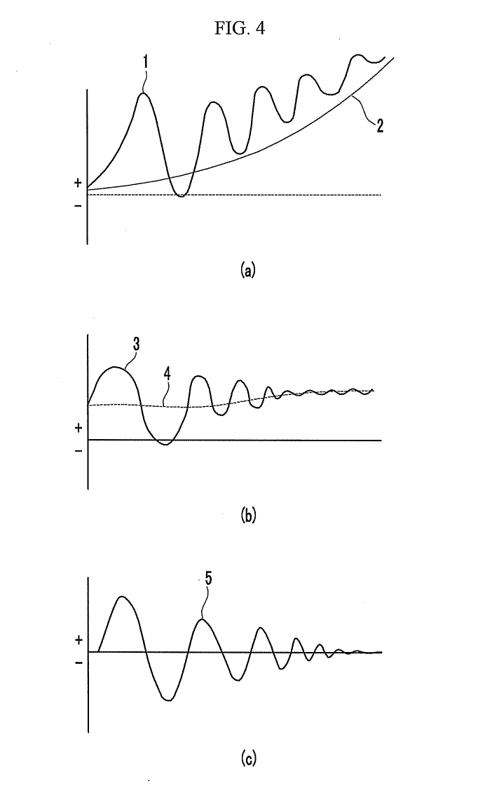

An actual rotational speed of the motor/generator 120 is detected by the rotational speed detector in S220 and a target rotational speed of the motor/generator 120 is calculated by the control portion 100 in S230. The speed difference between the actual rotational speed and the target rotational speed is calculated by the control portion 100 in S240 and an offset value is calculated by the control portion in S250. The offset value is described in a (b) of FIG. 4.

In S260, a speed vibration value is calculated by the values that have been described, a compensation value is determined in S270, and a compensated torque is applied through the motor/generator 120 in S280. Accordingly, the speed vibration is reduced in S290 and the control ends in S295.

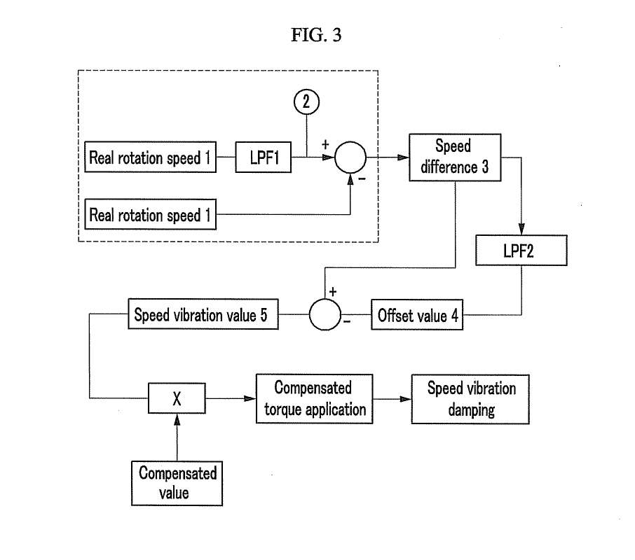

Referring to FIG. 3 and FIG. 4, the control method of the motor/generator 120 is specifically described. FIG. 3 is a flowchart showing a control method of a motor disposed in a vehicle according to an exemplary embodiment of the present invention. Referring to FIG. 3, an actual rotational speed 1 is input, the actual rotational speed 1 passes a first low pass filter LPF1, and a target rotational speed 2 is calculated.

The actual rotational speed 1 is deducted from the target rotational speed 2 to get a speed difference 3, and the speed difference passes a second low pass filter LPF2 to get an offset value 4. Here, if the offset value 4 is deducted from the speed difference 3, a speed vibration value 5 is calculated thereby, the speed vibration value 5 multiplied by the compensation value is a compensated torque, and the speed vibration is reduced by the compensated torque.

FIG. 4 is a graph showing a movement of a motor disposed in a vehicle according to an exemplary embodiment of the present invention. Referring to (a) of FIG. 4, 1 denotes an actual rotational speed of the motor/generator 120 and 2 denotes a target rotational speed of the motor/generator.

Referring to (b) of FIG. 4, 3 denotes a speed difference between the actual rotational speed and the target rotational speed and 4 denotes an offset value.

Referring to (c) of FIG. 4, 5 is a speed vibration value that is calculated by deducting the offset value from the speed difference value. A compensation value is applied to the speed vibration value and a compensated torque corresponding to the speed vibration value, to which the compensation value is applied, is applied so that the speed vibration can be reduced.

A target rotational speed is calculated by filtering an actual rotational speed of the motor/generator 120 without a hydraulic pressure sensor and a speed difference between the actual rotational speed and the target rotational speed is used to effectively reduce the speed vibration in an exemplary embodiment of the present invention.

Furthermore, the present invention may be embodied as computer readable media on a computer readable medium containing executable program instructions executed by a control device such as a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, such as a telematics server and controller area network.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

100: control portion
110: engine
120: motor/generator
130: brake system
140: rotational speed detector

What is claimed is:

1. A drive motor control method of a vehicle, comprising:
detecting, by a sensor, an actual rotational speed of a drive motor;
calculating, by a controller, a target rotational speed of the drive motor by filtering the actual rotational speed;
calculating, by the controller, a speed difference between the actual rotational speed and the target rotational speed;
calculating, by the controller, an offset value by filtering the speed difference;
calculating, by the controller, a speed vibration by deducting the offset value from the speed difference; and
reducing, by the controller, the speed vibration of the motor by applying a compensated torque in an opposite direction of the speed vibration based on the calculated speed vibration.

2. The drive motor control method of a vehicle of claim 1, wherein a compensation value is applied to the speed vibration value.

3. The drive motor control method of claim 1, wherein a first low pass filter is configured to filter the actual rotational speed and a second low pass filter filters the speed difference.

4. The drive motor control method of claim 1, wherein the drive motor is a motor/generator that uses a regenerative torque that is inputted through the output shaft to generate electricity and charges a battery with the electricity.

5. The drive motor control method of claim 1, further comprising an internal combustion engine that transforms explosion energy to a rotational torque, wherein the drive motor assists a rotational torque of the engine.

6. The drive motor control method of claim 1, wherein the actual rotational speed of the drive motor is detected and the actual rotational speed is filtered to calculate a target rotational speed, if a braking signal is detected.

7. A vehicle having a motor, comprising:
a drive motor configured to generate a torque and transfers the torque to an output shaft; and
a control portion configured to control a rotational speed and a rotational torque of the drive motor,
wherein the control portion,
detects a actual rotational speed of the drive motor,
calculates a target rotational speed of the drive motor by filtering the actual rotational speed,
calculates a speed difference between the actual rotational speed and the target rotational speed,
calculates an offset value by filtering the speed difference,
calculates a speed vibration value by deducting the offset value from the speed difference value, and
reduces the speed vibration of the motor by applying a compensated torque in an opposite direction of the speed vibration based on the calculated speed vibration.

8. The vehicle having a motor of claim 7, wherein the control portion is configured to apply a compensation factor to the speed vibration.

9. The vehicle having a motor of claim 7, further comprising,
a first low pass filter that filters the actual rotational speed, and
a second low pass filter that filters the speed difference.

10. The vehicle having a motor of claim 7, wherein the drive motor is a motor/generator that uses regeneration torque that is input from the output shaft to generate electricity, wherein the generated electricity charges a battery.

11. The vehicle having a motor of claim 7, wherein the control portion detects the actual rotational speed of the drive motor and filters the actual rotational speed to calculate the target rotational speed of the drive motor, when a braking signal is detected.

12. A computer readable medium containing executable program instructions executed by a control device, comprising:
program instructions that calculate a target rotational speed of the drive motor by filtering an actual rotational speed of a vehicle;
program instructions that calculate a speed difference between the actual rotational speed and the target rotational speed;
program instructions that calculate an offset value by filtering the speed difference;
program instructions that calculate a speed vibration by deducting the offset value from the speed difference; and
program instructions that reduce the speed vibration of the motor by applying a compensated torque in an opposite direction of the speed vibration based on the calculated speed vibration.

13. The computer readable medium of claim 12, further comprise program instructions that apply a compensation factor to the speed vibration.

14. The computer readable medium of claim 12, further comprising,
program instructions that apply a first low pass filter to filter the actual rotational speed, and
program instructions that apply a second low pass filter to filter the speed difference.

15. The computer readable medium of claim 12, further comprising program instructions that are configured to detect the actual rotational speed of the drive motor and filter the actual rotational speed to calculate the target rotational speed of the drive motor, when a braking signal is detected.
